(19) United States
(12) Patent Application Publication
(10) Pub. No.: US 2025/0023706 A1
(43) Pub. Date: Jan. 16, 2025

(54) CRYPTOGRAPHIC AGILITY FOR PRIVACY-PRESERVING FEDERATED LEARNING

(71) Applicant: VMware, LLC, Palo Alto, CA (US)

(72) Inventors: David OTT, Chandler, AZ (US); Martin Patrick STACK, Folsom, CA (US); Daniel James BEVERIDGE, Valrico, FL (US); Sean HUNTLEY, NSW (AU)

(21) Appl. No.: 18/351,528

(22) Filed: Jul. 13, 2023

(51) Int. Cl. H04L 9/00; G06N 3/098

(52) U.S. Cl. CPC H04L 9/008; G06N 3/098

(57) ABSTRACT

The disclosure provides an approach for cryptographic agility for privacy-preserving federated learning. Embodiments include receiving a request from an application for dynamic cryptographic technique selection related to a federated learning process, wherein the request indicates one or more types of mathematical operations that are to be performed by an aggregator device on data that is to be provided from multiple endpoints during the federated learning process. Embodiments include selecting, based on the one or more types of mathematical operations that are to be performed by the aggregator device, a cryptographic technique from a plurality of cryptographic techniques. Embodiments include providing a response to the application based on the selecting of the cryptographic technique, wherein the cryptographic technique is used to perform one or more cryptographic operations related to the federated learning process.

### BACKGROUND

Cryptography generally involves techniques for protecting data from unauthorized access. For example, data transmitted over a network may be encrypted in order to protect the data from being accessed by unauthorized parties. For example, even if the encrypted data is obtained by an unauthorized party, if the unauthorized party cannot decrypt the encrypted data, then the unauthorized party cannot access the underlying data. There are many types of cryptographic algorithms, and these algorithms vary in many aspects such as key size, ciphertext size, memory requirements, computation requirements, amenability to hardware acceleration, failure handling, entropy requirements, and the like. Key size refers to the number of bits in a key used by a cryptographic algorithm. Key size affects the strength of a cryptographic technique and is a configuration parameter. Having more bits in a key size results in more computation, but a larger space of possible mappings from cleartext to ciphertext, which is a quality makes it harder for an adversary to guess a key having a larger number of bits.

Ciphertext size refers to the number of bits in the output from a cryptographic algorithm, which may be the same as the number of bits of the input or may include padding to produce a larger number of bits than the input. Memory requirements and computation requirements generally refer to the amount of memory and processing resources required to perform an algorithm. Amenability to hardware acceleration generally refers to whether an algorithm requires or can be improved through the use of a hardware accelerator. For example, a compute accelerator is an additional hardware or software processing component that processes data faster than a central processing unit (CPU) of the computer. Failure handling refers to the processes by which an algorithm accounts for failures, such as recovering keys that are lost or deactivated. Entropy requirements generally refer to the amount of randomness required by an algorithm, such as an extent to which randomly generated values are used as part of the algorithm (e.g., which generally improves security of the algorithm).

Federated learning generally refers to privacy-preserving techniques in which a machine learning model is trained across multiple decentralized edge devices or servers that hold local data without exchanging the local data between the edge devices. In one example, edge devices perform local training and provide training results to an aggregator device, which aggregates the training results among the multiple edge devices to update a centralized model, which can then be re-distributed to the edge devices for subsequent training and/or use. Cryptography may be used in a federated learning process to protect data during transmission, such as between edge devices and an aggregator device. For example, edge devices may encrypt local data before sending it to the aggregator device, such as sharing an encryption key with the aggregator device via a separate secure channel, and the aggregator device may encrypt a final result of aggregation (e.g., a centralized model) in a similar manner before sending it back to the edge devices.

While existing federated learning techniques may protect data during transmission between endpoints, these techniques require the endpoints to be trusted with access to the unencrypted data. For example, an aggregator device must be trusted to access the local data from all participating edge devices. Furthermore, existing federated learning techniques rely on fixed cryptographic techniques, such as those that the software applications performing the federated learning operations are configured to support, and these fixed cryptographic techniques may not be optimal for the varying contexts in which federated learning techniques are performed.

As such, there is a need for improved techniques for secure and performant federated learning.

### BRIEF DESCRIPTION OF THE DRAWINGS

FIG. 1 is an illustration of example computing components related to cryptographic agility for privacy-preserving federated learning, according to embodiments of the present disclosure.

FIG. 2 is an illustration of an example related to dynamic cryptographic technique selection for privacy-preserving federated learning.

FIG. 3 depicts an example of tagging cryptographic techniques based on parameters, including supported mathematical operations.

FIG. 4 is a diagram depicting an example related to dynamic cryptographic technique selection for privacy-preserving federated learning.

FIG. 5 depicts example operations for dynamic cryptographic technique selection for privacy-preserving federated learning according to embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure relates to cryptographic agility for privacy-preserving federated learning. In particular, the present disclosure provides an approach for dynamically selecting and configuring ciphers based on parameters related to a federated learning process.

Cryptographic agility generally refers to techniques for dynamic selection and/or configuration of cryptographic algorithms. According to certain embodiments, logic related to selection and/or configuration of cryptographic algorithms is decoupled from the applications that utilize cryptographic functionality, and is implemented in one or more separate components. Thus, rather than an application directly calling a cryptographic library to perform cryptographic functionality, the application may call generic cryptographic functions provided by a separate cryptographic agility system, and the cryptographic agility system may then select and/or configure cryptographic algorithms, such as based on contextual information and/or policies. For instance, the cryptographic agility system may dynamically determine which libraries, algorithms, configuration values, and/or the like to select based on factors such as the type of data being encrypted, the type of application requesting encryption, the network environment(s) in which the data is to be sent, a destination to which encrypted data is to be sent, geographic locations associated with a source and/or destination of the data, attributes of users associated with the encryption, regulatory environments related to the encryption, network conditions, resource availability, performance constraints, device capabilities, and/or the like.

According to embodiments of the present disclosure, cryptographic techniques are dynamically selected based on attributes related to a federated learning process, such as whether an aggregator device is trusted to access the data being aggregated and/or based on the mathematical operations to be performed by an aggregator device in order to produce an aggregated result. In a particular example, different types of homomorphic encryption algorithms may be dynamically selected for privacy-preserving federated learning based on factors including the mathematical operations that are to be performed in the federated learning process. For example, while many cryptographic techniques involve encrypting data at the source and decrypting the data at the destination in order to protect the privacy of the data during transmission, homomorphic encryption techniques provide an additional benefit of preserving the privacy of the data while it is processed at the destination, thereby allowing for arrangements in which the data is never decrypted at the destination.

Homomorphic encryption generally refers to encryption techniques that allow one or more types of mathematical operations to be performed on encrypted data without decryption and without exposing the underlying data. With homomorphic encryption, the result of performing a mathematical operation on the encrypted data remains in an encrypted form which, when decrypted, results in an output that is identical to that produced had the mathematical operation been performed on the unencrypted data.

According to techniques described herein, selecting a homomorphic encryption technique for use in a federated learning process allows an aggregator device to perform computations on encrypted data received from multiple endpoints (e.g., edge devices) without the aggregator device being granted access to the unencrypted data, and thereby preserving the privacy of the underlying data, while producing an aggregated result that can be decrypted by the endpoints as if the computations had been performed on the unencrypted data. While an aggregator device could otherwise learn about a private data set from parameter information that is sent as part of a federated learning process, embodiments of the present disclosure prevent such disclosure of private information through the use of dynamically-selected homomorphic encryption techniques. For example, if local models at multiple edge devices are being trained based on local data that is sensitive (e.g., medical information, personally identifiable information (PII), classified information, private user data, and/or the like) and yet there is a desire to train a global model that is not biased by the potentially unique attributes of the local data, the edge devices may encrypt their local model parameters (e.g., gradients) using homomorphic encryption and then send the encrypted local model parameters to the aggregator device for aggregation in a privacy-preserving manner. The aggregator device may perform computations on the encrypted local model parameters received from the edge devices in order to determine global model parameters (which will remain encrypted). The global model parameters, when sent back to the edge devices, can be decrypted using the same homomorphic encryption key or keys used to encrypt the local model parameters in order to produce an unencrypted global model at the edge devices.

However, there are different types of homomorphic encryption algorithms that support different types of mathematical operations. For example, some homomorphic encryption algorithms only allow addition to be performed on the encrypted data, some homomorphic encryption algorithms allow multiplication to be performed on the encrypted data, and some homomorphic algorithms are “fully homomorphic” such that they support the full range of possible mathematical operations on the encrypted data. Generally, a fully homomorphic encryption algorithm allows the evaluation of arbitrary circuits composed of multiple types of gates of unbounded depth and is the strongest notion of homomorphic encryption. Furthermore, different homomorphic encryption algorithms may support different numbers of mathematical operations of different types. For example, certain homomorphic encryption algorithms may support a given type of mathematical operation (e.g., multiplication) but may only support a limited number of instances of that given type of mathematical operations while still maintaining homomorphic properties.

Different homomorphic encryption algorithms have different levels of security and/or vary in the amount of computing resources (e.g., processing, memory, and/or network resources) that are utilized during encryption, decryption, and transmission of encrypted data. For example, fully homomorphic encryption algorithms are generally resource-intensive, and so cannot be used on devices with limited available computing resources. Thus, according to embodiments of the present disclosure, different types of homomorphic encryption may be dynamically selected for different situations based on, for example, which mathematical operations are to be performed by the aggregator device. For instance, if the aggregator device only needs to perform addition then it may not be necessary to utilize a homomorphic encryption technique that supports more complex types of mathematical operations and that utilizes a higher amount of computing resources, and so a homomorphic encryption algorithm that only supports addition may be selected. Furthermore, a homomorphic encryption technique may be selected based on how many times a given type of mathematical operation is to be performed on the given data, which may be indicated in a request that is sent to the cryptographic agility system to encrypt data. Furthermore, there are many different types of fully homomorphic encryption techniques and many different types of partially homomorphic encryption techniques, including many different potential configurations of many different potential algorithms associated with many different potential libraries, and selection among these different techniques may be based on a variety of factors, such as the mathematical operations to be performed, the resource-efficiency of these techniques, the level of security of these techniques, attacks protected against, device limitations, and/or the like.

In some embodiments, a variety of additional factors may also be used to dynamically select an encryption algorithm for a privacy-preserving federated learning process. For example, policies may be defined by users (e.g., administrators), and may specify rules for selecting and/or configuring cryptographic algorithms. Policies may specify, for example, conditions under which cryptographic techniques must comply with one or more standards (e.g., Federal Information Processing Standards or FIPS), when a quantum-safe cryptographic technique must be selected, how to select among different quantum-safe cryptographic techniques, conditions for selecting key sizes (e.g., based on a desired level of security or based on different algorithm standards such as particular elliptical curves), and/or the like. In one example, cryptographic techniques (e.g., algorithms and/or configurations of algorithms) are tagged with different levels of security (e.g., rated from 0-10), and a policy associated with an application may specify that all data that is to be transmitted from the application to a destination in a given type of networking environment, such as a public network, is to be encrypted using a high-security algorithm (e.g., rated 8 or higher). Thus, if the application calls a function provided by the cryptographic agility system to encrypt an item of data for a federated learning process, and contextual information indicates that the data is to be transmitted to a device (e.g., an aggregator device) on a public network, then the cryptographic agility system, in certain embodiments, will select a cryptographic algorithm tagged as a high-security algorithm, such as with a security rating of 8 or higher, such as in addition to being a homomorphic encryption algorithm that supports the required mathematical operations. In another example, cryptographic techniques are tagged with indications of whether they comply with particular standards, and a policy may specify that all data associated with a particular application or for a particular purpose is to be encrypted with a cryptographic technique that complies with a particular standard (e.g., FIPS). In such an example, if an application calls a function provided by the cryptographic agility system to encrypt an item of data, and contextual information indicates that the data relates to the particular purpose or that the application is the particular application, then the cryptographic agility system, in certain embodiments, will select a cryptographic algorithm tagged as being compliant with the particular standard.

In yet another example, cryptographic techniques are tagged with indications of whether they have certain characteristics or support certain configurations, and a policy may specify that all data that is to be transmitted as part of a federated learning process is to be encrypted using a cryptographic technique that does or does not have one or more particular characteristics or configurations. Thus, if the cryptographic agility system receives a request to encrypt an item of data for a federated learning process, then the cryptographic agility system, in certain embodiments, will select a cryptographic algorithm tagged with indications that the cryptographic algorithm does or does not have the one or more particular characteristics or configurations indicated in the policy. Accordingly, an organization or user may specify policies based on their own preferences of which characteristics or configurations of cryptographic techniques are most secure or desirable and/or based on specific compliance requirements.

By decoupling cryptographic logic from applications that rely on cryptographic functionality for performing federated learning operations, cryptographic agility techniques described herein provide flexibility and extensibility, thus allowing cryptographic algorithms to be continually updated, changed, and otherwise configured without requiring modifications to the applications themselves, such as allowing for the utilization of new types of homomorphic encryption that are not natively supported by the application. Accordingly, changing circumstances may be addressed in a dynamic and efficient manner, and computing security may thereby be improved. For example, endpoints may utilize techniques described herein to dynamically select privacy-preserving cryptographic techniques for use in encrypting local parameters to send to an aggregator device, and the aggregator device may utilize techniques described herein to encrypt a global model trained based on aggregating the received local parameters from the endpoints. In some embodiments, the aggregator device may not need to encrypt the global model, as it may have been generated based on homomorphically encrypted local parameters, and thus the global model parameters may remain encrypted until they are unencrypted by the endpoints upon receipt.

According to embodiments of the present disclosure, cryptographic techniques are dynamically selected and/or configured for use in federated learning operations based on additional factors such as network and/or resource constraints. In some cases, a cryptographic algorithm may be referred to as a “cipher”. Cryptographic algorithms have varying resource requirements, such as different memory, processing, and/or communication resource requirements. For example, some algorithms are more computationally-intensive than others and some algorithms involve storage and/or transmission of larger amounts of data than others. For example, algorithms involving larger key sizes or ciphertext sizes generally require larger amounts of memory and/or network communication resources than algorithms with smaller key sizes or ciphertext sizes. In another example, the larger the number of bits of security used in an algorithm, the more processing-intensive the algorithm will generally be.

In a cryptographic agility system, an initial stage of selecting a cryptographic technique may involve ensuring that the security requirements for a given cryptographic operation, such as a level of security required by policy and/or context information, are met. However, there may be multiple algorithms and/or configurations of algorithms that meet these requirements. Thus, techniques described herein involve factoring operation-related considerations (e.g., which mathematical operations are to be performed in a federated learning process) and, in some embodiments, resource-related considerations, into the determination of which algorithms and/or configurations to use, such as based on information associated with a request and/or based on device and/or network performance metrics and/or capability information.

Cryptographic algorithms and/or configurations of algorithms may be tagged based on supported mathematical operations and/or based on resource requirements, such as by an administrator. For example, a given algorithm or configuration of an algorithm may be tagged with an indication of supported mathematical operations and/or with a classification with respect to each of memory requirements, processing requirements, network resource requirements, and/or the like. Classifications may take a variety of forms, such as high, medium, and low, numerical scales (e.g., 0-10), binary indications, and/or the like. In some embodiments, classifications may be imported from one or more sources, such as cryptographic technique providers, open source entities, standards bodies, and/or the like. In some embodiments, rather than individual algorithms or configurations being tagged, types of algorithms and/or configurations are tagged with supported mathematical operations and/or classifications relating to various types of resource requirements. For example, a tag may indicate that all “additive” homomorphic encryption algorithms support addition. In another example, a tag may indicate that all fully homomorphic encryption algorithms are associated with a high processing resource requirement. In yet another example, a tag may indicate that all algorithms that involve the use of an accelerator are associated with a high processing resource requirement. An accelerator is a hardware device or a software program that enhances the overall performance of a computer, such as by processing data faster than a central processing unit (CPU) of the computer (e.g., which may be referred to as a compute accelerator). It is noted that CPUs may in some cases have special instructions for accelerating cryptographic operations, such as the Advanced Encryption Standard New Instructions (AES-NI) instruction set from Intel®, and a tag may indicate that a cryptographic technique is or is not compatible with such special instructions. Furthermore, cryptographic algorithms and/or configurations of algorithms may be tagged with indications of capability requirements, such as whether an accelerator and/or other specialized hardware is required.

When a cryptographic request is submitted by an application, the cryptographic agility system may gather information associated with the request (e.g., from the request itself, from metadata associated with the request, and/or through communication with one or more other components) related to the operations to be performed in a federated learning process. Furthermore, the cryptographic agility system may gather information related to resource conditions and/or capabilities of the network and/or devices related to the cryptographic request. For instance, the cryptographic agility system may gather current resource availability (e.g., based on capacity and utilization), performance metrics, capability information, and the like for the device and/or network from which the request is received. Techniques for gathering such information are known in the art and may involve, for example, including contextual information in the cryptographic request, communication with one or more performance monitoring components, and/or the like.

Thus, the cryptographic agility system may select algorithms and/or configurations of algorithms that are best suited to the mathematical operations to be performed in the federated learning process and, in some embodiments, to the resource availability, performance, and/or capabilities of the device and/or network associated with the request. For example, if processing resource availability at a device is low (e.g., if processor utilization is high), then ciphers that support the required mathematical operations and yet have low processing requirements may be selected. In another example, if network latency is high (e.g., for a satellite-based network) or if memory availability is low, then ciphers that support the required mathematical operations and yet have smaller key sizes or ciphertext sizes may be selected in order to reduce the amount of data that will need to be stored and/or transmitted over the network to implement the cryptographic algorithm.

In some cases, multiple cryptographic algorithms and/or configurations of algorithms may be used to service a single cryptographic request. For instance, if a new, more secure cryptographic algorithm has recently become available but is not yet certified by a particular organization, and a particular cryptographic request requires cryptography that is certified by the particular organization, a certified algorithm may first be used and then the new algorithm may be used on top of the certified algorithm to provide the added level of security.

Furthermore, for a federated learning process, the multiple endpoints that send homomorphically encrypted data to an aggregation device may encrypt local data using a single encryption key that is shared across the endpoints (but not with the aggregation device) and/or may use different encryption keys, such as using a multi-key homomorphic encryption scheme (e.g., so that one endpoint is unable to decrypt the local data from another endpoint even if it were to obtain such local data). In some embodiments, attribute based encryption (ABE) techniques may be used in order to provide more fine-grained access control for encrypted data that is sent by endpoints to an aggregation device. For example, ABE techniques may allow multiple private keys to be used with a single public key, such as allowing each endpoint in a federated learning process to use a distinct private key, while all of the endpoints may use a common public key that is constructed from a list of attributes such that any party that has all of the attributes can decrypt the data.

According to certain embodiments, cryptographic techniques used for a federated learning process may be centrally selected and/or orchestrated, such as by the aggregator device, one of the endpoints, or another centralized component. For example, the centralized component may invoke generic cryptographic functionality provided by the cryptographic agility system described herein (e.g., a generic cryptography module may be located on the same device as the centralized component or may be otherwise in communication with the centralized component) in order to dynamically select one or more cryptographic techniques for use in a federated learning process involving a plurality of endpoints and one or more aggregator devices, such as providing contextual information related to the federated learning process to the cryptographic agility system. In some cases, the endpoints may transmit local contextual information to the centralized component (e.g., securely, such as in encrypted form), and the centralized component may use the contextual information received from the endpoints to provide contextual information to the cryptographic agility system, such as based on a lowest common denominator across the contextual information received from the endpoints or some other aggregation of the contextual information received from the endpoints. The cryptographic agility system may then dynamically select one or more cryptographic techniques for use in the federated learning process (e.g., based on the contextual information as described herein) and provide information about the selected one or more cryptographic techniques to the centralized component. The centralized component may then distribute at least subsets of the information about the one or more selected cryptographic techniques to the endpoints (and, in some embodiments, to the aggregator device) such that the endpoints can use the selected one or more cryptographic techniques to encrypt local data prior to sending such local data to the aggregator device. The endpoints may perform encryption using the selected one or more cryptographic techniques themselves or may interact with one or more other components, such as one or more generic cryptography modules, to perform the encryption. The aggregator device may be provided with instructions (e.g., by the centralized component) indicating whether the aggregator device is to decrypt the received local parameters (e.g., if non-homomorphic encryption is used) or to perform aggregation on the encrypted local parameters (e.g., if homomorphic encryption is used).

As such, embodiments of the present disclosure improve upon conventional cryptography techniques for federated learning processes in which cryptographic algorithms are pre-determined for applications (e.g., at design time), and in which the aggregator device is given access to the unencrypted data, by providing for the dynamic selection of homomorphic encryption techniques that are tailored for the operations to be performed and for the devices and networks involved, and that may not be natively supported by the applications performing the federated learning processes. For example, by selecting targeted homomorphic encryption algorithms and/or configurations based on the operations to be performed and based on network and/or resource constraints, techniques described herein improve the functioning of devices and networks on which cryptographic operations are performed by ensuring that cryptographic operations do not burden devices or networks beyond their capacity or capabilities while preserving the privacy of local data, such as allowing an aggregator device to perform required operations without being granted access to the underlying data. As such, the aggregator device does not need to be trusted with data access, and can be located in an untrusted networking environment (e.g., the Internet or a public cloud environment). Additionally, the aggregator device does not need to decrypt the data before performing aggregation functions, thereby reducing computing resource utilization at the aggregator device and improving the functioning of the computing system. Furthermore, embodiments of the present disclosure improve information security by ensuring that the most secure and updated cryptographic techniques that are consistent with required operations and with device and network constraints may be utilized by an application, even if such techniques were not available at the time the application was developed.

Additionally, techniques described herein may facilitate an organization's use of uniform policy configuration (e.g., a suite of coordinated policies), such as to orchestrate cryptographic usage across many endpoints (e.g., involved in a federated learning process). Embodiments of the present disclosure may also be used to facilitate migration to new homomorphic encryption algorithms at scale and/or to remove deprecated homomorphic encryption algorithms from use in a centralized and coordinated manner.

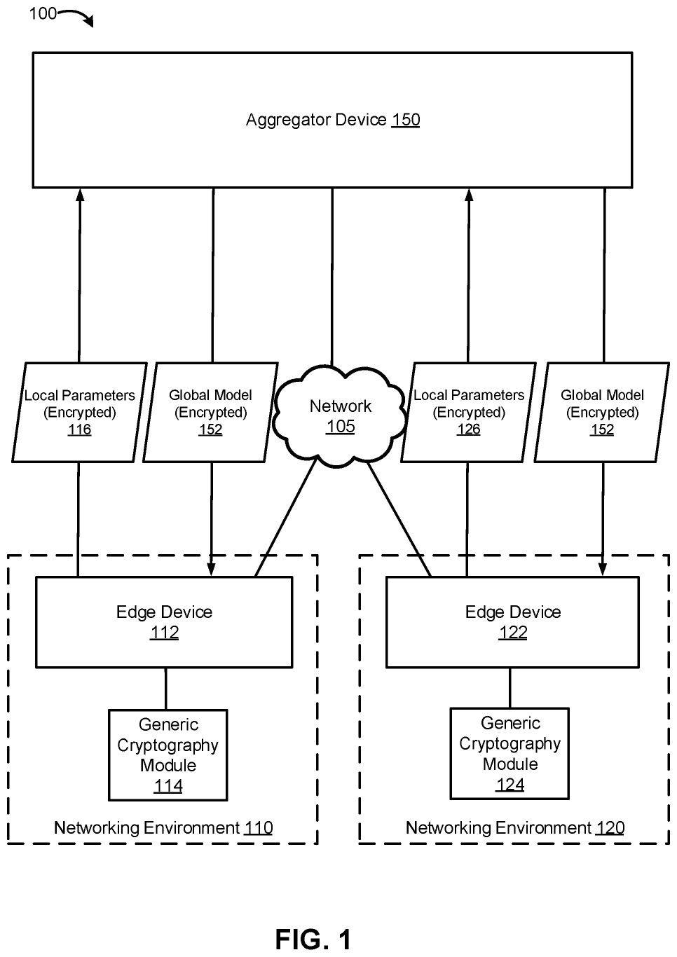

FIG. 1 is an illustration 100 of example computing components related to cryptographic agility for privacy-preserving federated learning, according to embodiments of the present disclosure.

An example federated learning process involves multiple endpoints, such as edge devices 112 and 122 in separate networking environments 110 and 120, sending local parameters 116 and 126 to an aggregator device 150 for aggregation, and aggregator device 150 sending a global model 152 produced as a result of the aggregation back to the endpoints. It is noted that federated learning does not necessarily involve the creation of a global machine learning model and could also involve the creation of global learned parameters or determinations that are sent back to the endpoints. As such, the term model as used herein is not intended to limit federated learning processes to the creation of machine learning models.

Networking environments 110 and 120 may be separate networks, such as data centers (e.g., physical data centers or software defined data centers), cloud environments, local area networks (LANs), and/or the like. In certain embodiments, networking environments 110 and 120 are private networking environments that implement security mechanisms (e.g., firewalls) to prevent unauthorized access. Edge devices 112 and 122 represent physical or virtual devices that provide entry points into networking environments 110 and 120. For example, in some embodiments, communications to and from networking environment 110 are received and/or transmitted via edge device 112 and communications to and from networking environment 120 are received and/or transmitted via edge device 122. Edge devices 112 and 122 communicate with an aggregator device 150 via a network 105, which may be any sort of connection over which data may be transmitted. In certain embodiments, network 105 is a wide area network (WAN) such as the Internet.

Aggregator device 150 generally represents a physical or virtual device that performs aggregation functionality for a federated learning process. Aggregator device 150 may be located, for example, in a public networking environment, such as a public cloud. In one example, aggregator device 150 is a cloud service. In other examples, aggregator device may be located in one of networking environments 110 or 120 and/or may be located in a different private or public networking environment. While not shown, aggregator device 150 may, in some embodiments, also include and/or may be associated with a generic cryptography module similar to generic cryptography modules 114 and 124.

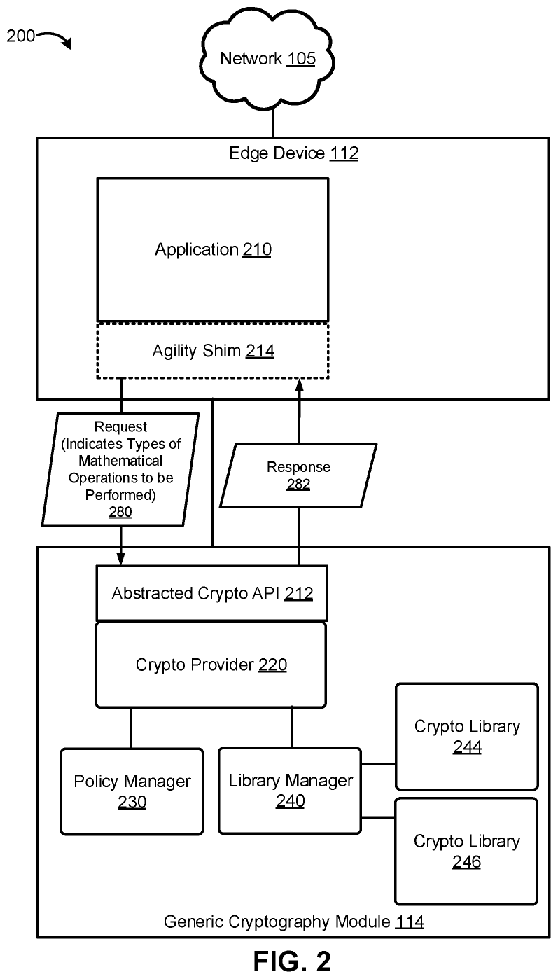

Edge devices 112 and 122 communicate with generic cryptography module 114 and 124 in order to perform cryptographic functionality related to the federated learning process. As described in more detail below with respect to FIG. 2, generic cryptography module 114 and 124 may be physical or virtual computing devices, such as server computers or virtual computing instances (VCIs), on which components of a cryptographic agility system reside. For example, generic cryptography module 114 and 124 generally perform operations related to dynamically selecting cryptographic techniques (e.g., based on contextual information related to requests for cryptographic operations), performing the requested cryptographic operations according to the selected techniques, and providing results of the operations to the requesting components. It is noted that while generic cryptography module 114 and 124 are shown as separate devices from edge devices 112 and 122 in networking environments 110 and 120, these generic cryptography module may alternatively be implemented on the same devices as edge devices 112 and/or 122 (e.g., as separate software components).

In an example, edge devices 112 and 122 send requests to generic cryptography modules 114 and 124 to encrypt local data (e.g., local model parameters determined through a local model training process based on local training data), such as indicating one or more types of mathematical operations to be performed by aggregator device 150 in the request. In certain embodiments, the request further indicates how many times one or more given types of mathematical operations are to be performed. Generic cryptography modules 114 and 124 dynamically select one or more cryptographic techniques such as homomorphic encryption algorithms based on attributes associated with the request, such as the operations to be performed, how many times such operations are to be performed, computing resource and/or capability constraints, policy considerations, and/or the like. In some embodiments, generic cryptography modules 114 and 124 communicate with each other, such as via a secure channel established between them, to coordinate aspects of the one or more selected encryption techniques. In an example, generic cryptography modules 114 and 124 securely share an encryption key that is used at both generic cryptography modules 114 and 124 to encrypt local data. In another example, generic cryptography modules 114 and 124 coordinate a multi-key homomorphic encryption scheme with one another so that a key does not need to be shared between generic cryptography modules 114 and 124.

After dynamically selecting one or more encryption techniques, generic cryptography modules 114 and 124 may encrypt the respective local data using the selected technique(s) and return the respective encrypted local data to edge devices 112 and 122. In alternative embodiments, generic cryptography modules 14 and 124, rather than performing encryption themselves, may provide information to one or more other components, such as edge devices 112 and 122 and/or other encryption components, to perform the selected encryption technique(s).

Edge devices 112 and 122 send the encrypted local parameters 116 and 126 to aggregator device 150, which performs aggregation functionality. For example, aggregator device 150 may perform one or more mathematical operations, such as addition, subtraction, division, and/or multiplication in order to aggregate encrypted local parameters 116 and 126. In one example, aggregator device 150 calculates an average of encrypted local parameters 116 and 126 by adding encrypted local parameters 116 and 126 and dividing the sum by the total number of edge devices involved in the federated learning process (e.g., which is two in the depicted example). It is noted that in many embodiments the number of participating endpoints (e.g., edge devices) will be larger than two. Furthermore, participating endpoints need not be edge devices, and edge devices are included as an example. Additionally, aggregation is not limited to averaging, and other types of aggregation computations may alternatively be performed. The local parameters that are aggregated to produce global parameters may include, for example, gradients, weights, hyperparameters, and/or the like. Local parameters may include information that is specific to particular participants (e.g., endpoints) in the federated learning process, and thus may include sensitive information that the participants do not want revealed to the aggregator device (or to the other participants).

In certain embodiments, aggregator device 150 is associated with a generic cryptography module, and generic cryptography modules 114 and/or 12 may communicate with the generic cryptography module associated with aggregator device 150 as part of the federated learning process. For example, the generic cryptography module associated with aggregator device 150 may be notified that the data being sent has been encrypted using homomorphic encryption, and that computations can be performed on the data without decryption.

The results of computations performed by aggregator device 150 on encrypted local parameters 116 and 126 will remain encrypted, such that aggregator device 150 will not have access to the unencrypted local parameters or the unencrypted global parameters. Aggregator device 150 sends an encrypted global model (e.g., produced as a result of the aggregation functionality, such as comprising the encrypted global parameters, which may in one example be the average of the local parameters) to edge devices 112 and 122.

Edge devices 112 and 122 may decrypt the encrypted global model 152 using the key(s) with which encrypted local parameters 116 and 126 were encrypted in order to determine the unencrypted global model. For example, edge devices 112 and 122 may send requests to generic cryptography modules 114 and 124 to decrypt the encrypted global model 152, and generic cryptography modules 114 and 124 may perform decryption and return the unencrypted global model to edge devices 112 and 122. As a result of the use of homomorphic encryption, the unencrypted global model will be the same as if the computations performed by aggregator device 150 has been performed on the unencrypted local data from edge devices 112 and 122. Thus, edge devices 112 and 122 are provided with a global model that benefits from the local training performed at all endpoints without being biased by peculiar attributes of local training data from any individual endpoint. Furthermore, the privacy of the local data is preserved, as aggregator device 150 is never granted access to the unencrypted local data or the unencrypted global data, and the unencrypted local data is never shared between different endpoints. Additionally, computing resource constraints and capabilities of the computing devices and networks are respected through the dynamic selection of encryption techniques based on such constraints and capabilities, such as selecting one or more homomorphic encryption techniques that support the particular mathematical operations that are to be performed by aggregator device 150 (and that comply with one or more additional policies) and that also are well-suited to the devices and networks involved in the federated learning process.

It is noted that while certain embodiments are described in which an aggregator device performs aggregation on encrypted data from endpoints and sends results of the aggregation back to the endpoints, other embodiments may involve the aggregation device acting as a sort of middle box that performs aggregation on encrypted data from endpoints and then sends results of the aggregation to one or more different endpoints (e.g., different than the endpoints from which the encrypted data was received). For example, the one or more different endpoints may be provided one or more decryption keys (e.g., used to generate the encrypted data) by the one or more endpoints, and the one or more different endpoints may use the one or more decryption keys to decrypt the results of the aggregation received from the aggregation device.

FIG. 2 is an illustration 200 of an example related to dynamic cryptographic technique selection for privacy-preserving federated learning, according to embodiments of the present disclosure. Illustration 200 includes network 105, edge device 112, and generic cryptography module 114 of FIG. 1.

Edge device 112 may be a physical or virtual computing device, such as a server computer, that runs an application 210. In some embodiments, edge device 112 may be a virtual computing instance (VCI), such as a virtual machine (VM) or container that runs on a physical host computer that includes one or more processors and/or memory devices. It is noted that edge device 112 is included as an example computing device on which application 210 and/or associated components may be located, and other types of devices may also be used.

Application 210 generally represents a software application that requires cryptographic functionality. For example, application 210 may rely on cryptographic functionality to encrypt data that it transmits over a network (e.g., network 105), such as to aggregator device 150 of FIG. 1. In one example, application 210 performs operations related to federated learning, such as sending local model parameters (e.g., which may have been generated at edge device 112 and/or one or more other devices involved in a local model training process based on local training data) to an aggregator device for aggregation with local parameters from other edge devices. While conventional techniques generally involve direct integration of cryptographic libraries with applications that rely on cryptographic functionality, such as for transmitting data associated with a federated learning process, techniques described herein involve abstracting cryptographic functionality away from such applications. As such, an abstracted crypto application programming interface (API) 212 is provided as a means of interaction between application 210 and a separate cryptographic agility system. Application 210 may call generic cryptographic functions of abstracted crypto API 212 in order to invoke particular cryptographic functionality, and the cryptographic agility system may select cryptographic techniques and perform cryptographic operations in response to the function invocations based on contextual information (e.g., including the types of mathematical operations to be performed). Thus, application 210 may be merely a consumer of cryptography provided by the separate cryptographic agility system, rather than implementing cryptography itself. For example, techniques described herein allow a vendor to provide a federated learning homomorphic encryption system that allows a customer to provide its own cryptographic modules, such as registering such cryptographic modules with a generic cryptographic module.

The cryptographic agility system includes abstracted crypto API 212 and, in certain embodiments, an optional agility shim 214, as well as crypto provider 220, policy manager 230, and library manager 240. In some embodiments, while depicted as separate components, the functionality associated with agility shim 214, abstracted crypto API 212, policy manager 230, and/or library manager 240 may be part of crypto provider 220 and/or may be implemented by more or fewer components. In certain embodiments, abstracted crypto API 212 and/or agility shim 214 are part of application 210. In alternative embodiments, abstracted crypto API 212 and/or agility shim 214 may be located on a separate device from edge device 112, such as on the same device as generic cryptography module 114 or a different computing device.

Agility shim 214 generally intercepts API calls (e.g., calls to functions of abstracted crypto API 212) and redirects them to crypto provider 220 via abstracted crypto API 212. Shims generally allow new software components to be integrated with existing software components by intercepting, modifying, and/or redirecting communications. As such, agility shim 214 allows application 210 to interact with crypto provider 220 even though application 210 may have no knowledge of crypto provider 220. For instance, application 210 may make generic function cryptographic function calls (e.g., requesting that an item of data be encrypted), and these generic function calls may be intercepted by agility shim 214 (e.g., if such a shim is needed) and redirected to crypto provider 220 via the abstracted crypto API 212 exposed by crypto provider 220.

It is noted that while embodiments of the present disclosure are depicted on edge device 112 and generic cryptography module 114, alternative embodiments may involve various components being located on more or fewer computing devices. In some cases, aspects of the cryptographic agility system may be implemented in a distributed fashion across a plurality of computing devices. In certain embodiments, said components may be located on a single computing device.

In certain embodiments, generic cryptography module 114 comprises a physical or virtual computing device, such as a server computer, on which components of the cryptographic agility system, such as crypto provider 220, policy manager 230, and/or library manager 240, reside. For example, generic cryptography module 214 may represent a VCI or a physical computing device. Generic cryptography module 214 may be connected to network 105 and/or one or more additional networks (e.g., networking environment 110 of FIG. 1).

Crypto provider 220 generally performs operations related to dynamically selecting cryptographic techniques (e.g., based on contextual information related to requests for cryptographic operations, such as the types of mathematical operations to be performed in a federated learning process and/or how many times such operations are to be performed), performing the requested cryptographic operations according to the selected techniques, and providing results of the operations to the requesting components. Cryptographic techniques may include cryptographic algorithms (e.g., included in one or more libraries) and/or specific configurations of cryptographic algorithms, as described herein. In some embodiments, the cryptographic agility system is located on the same device as application 210, while in other embodiments the cryptographic agility system is located on a separate device, such as on a server that is accessible over a network.

In certain aspects, crypto provider 220 has two major subsystems, policy manager 230 and library manager 240. Policy manager 230 performs operations related to cryptographic policies, such as receiving policies defined by users and storing information related to the policies, such as in a policy table. According to certain embodiments, a centralized policy control server may orchestrate policy across a plurality of generic cryptography modules, such as including generic cryptography module 114. For example, an administrator or other user may configure one or more policies at a centralized policy control server, and the one or more policies may be distributed to a plurality of generic cryptography modules for storage by corresponding policy managers, such as including policy manager 230. In an example, a policy is based on one or more of an organizational context and a user context related to a cryptographic request. In some embodiments, a policy may map a cryptographic request and its associated context information to attributes of cryptographic techniques, such as a particular cryptographic technique in a particular cryptographic library and a particular set of parameters for configuring the particular cryptographic technique.

Organizational context may involve geographic region (e.g., country, state, city and/or other region), industry mandates (e.g., security requirements of a particular industry, such as related to storage and transmission of medical records), government mandates (e.g., laws and regulations imposed by governmental entities, such as including security requirements), and the like. For instance, a policy may indicate that if a cryptographic request is received from a device associated with a particular geographic region, associated with a particular industry, and/or within the jurisdiction of a particular governmental entity, then crypto provider 220 must select a cryptographic technique that meets one or more conditions (e.g., having a particular security rating and/or being configured to protect against particular types of threats) in order to comply with relevant laws, regulations, or mandates.

User context may involve user identity (e.g., a user identifier or category, which may be associated with particular privileges), data characteristics (e.g., whether the data is sensitive, classified, or the like), application characteristics (e.g., whether the application is a business application, an entertainment application, or the like), platform characteristics (e.g., details of an operating system), device characteristics (e.g., hardware configurations and capabilities of the device, resource availability information, and the like), device location (e.g., geographic location information, such as based on a satellite positioning system associated with the device), networking environment (e.g., a type of network to which the device is connected, such as a satellite or land-based network connection), and/or the like. For example, a policy may indicate that if a cryptographic request is received from a particular category of user (e.g., administrators, general users, or the like), relating to a particular type of data (e.g., tagged as sensitive or meeting characteristics associated with sensitivity, such as being financial or medical data), associated with a particular application or type of application, associated with a particular platform (e.g., operating system), from a device with particular capabilities or other attributes (e.g., having a certain amount of processing or memory resources, having an accelerator, having one or more particular types of processors, and/or the like), from a device in a particular location (e.g., geographic location) or type of networking environment (e.g., cellular network, satellite-based network, land network, or the like), and/or that is to be transmitted to a device having one or more particular characteristics (e.g., being untrusted, being located in a public networking environment, being located in a particular geographic region, and/or the like), then crypto provider 220 should select a cryptographic technique that meets one or more conditions.

In one example, a policy indicates that if a request relates to encrypting data that is to be transmitted to a device that is untrusted for one or more reasons for computation to be performed on the data, then a homomorphic encryption technique should be selected. In certain embodiments, a policy may specify that, unless otherwise required (e.g., because of another policy, such as related to security level), a homomorphic encryption technique that supports the required mathematical operations while having the lowest resource utilization requirements of all such homomorphic encryption techniques is to be selected. In certain embodiments, a policy may simply specify an allowed list of ciphers or an allowed list of cryptographic technique characteristics. In some cases, a policy may relate to resource constraints (e.g., based on available processing, memory, network, physical storage, accelerator, entropy source, or battery resources), such as specifying that cryptographic techniques must be selected based on resource availability (e.g., how much of a device's processing and/or memory resources are currently utilized, how much latency is present on a network, and the like) and/or capabilities (e.g., whether a device is associated with an accelerator) associated with devices and/or networks, while in other embodiments crypto provider 220 selects cryptographic techniques based on resource constraints and/or supported mathematical operations independently of policy manager 230 (e.g., for all applicable cryptographic requests regardless of whether any policies are in place). For example, policies may only relate to security levels of cryptographic techniques, such as requiring the use of cryptographic techniques associated with particular security ratings when certain characteristics are indicated in contextual information related to a cryptographic request, and resource constraints may be considered separately from policies. In one example, once all cryptographic techniques meeting the security requirements and/or mathematical operation requirements for a cryptographic request are identified (e.g., based on policies or otherwise), a cryptographic technique is selected from these compliant cryptographic techniques based on resource constraints.

It is noted that resource constraints and/or capabilities may include a variety of different types of information, such as processor availability and/or capabilities (e.g., clock rate, number of cores, instruction-level features such as single instruction multiple data (SIMD) instructions, types of processors, and/or the like) memory availability and/or capabilities (e.g., memory size and performance), accelerator capabilities (e.g., hardware-based cryptographic accelerator units available for use with the device), battery capabilities (e.g., lifetime, current power remaining, and/or the like), information about entropy (e.g., how much entropy is available for random numbers, the source of entropy such as an OS, hardware module, CPU platform, or the like, whether available entropy sources are federal information processing standards (FIPS) compliant, and/or the like), network connectivity information (e.g., bandwidth, loss metrics for the channel, congestion, latency, and/or the like), information about the device's physical exposure to potential side-channel attacks and/or ease of side channel analysis, and/or the like. Thus, any of these types of data points may be gathered from devices and/or networks, and may be used in selecting cryptographic techniques (e.g., based on policies and/or tags related to these data points associated with cryptographic techniques).

A policy table may store information related to policies. In some embodiments, a policy table maps various contextual conditions (e.g., relating to organizational context and/or user context) to cryptographic technique characteristics (e.g., supported mathematical operations, security ratings, threats protected against, resource utilization ratings, and the like). For example, a contextual condition may be the use of a certain type of application, the requirement of certain mathematical operations to be performed on encrypted data, a certain type of data, or a particular geographic location. A cryptographic technique characteristic may be, for example, whether the cryptographic technique is homomorphic, supported mathematical operations, a security rating (e.g., 0-10), whether the cryptographic technique is quantum-safe, what level of resource requirements the cryptographic technique has for a particular type of resource (e.g., memory, processor, or network resources), or the like. Thus, when cryptographic requests are received, a policy table may be used to determine whether the cryptographic requests are associated with any characteristics included in policies and, if so, what cryptographic technique characteristics are required by the policies for servicing the requests.

Library manager 240 generally manages cryptographic libraries containing cryptographic algorithms. For example crypto libraries 244 and 246 each include various cryptographic algorithms, each of which may include configurable parameters, such as key size, choice of elliptic curve, algorithm sizing parameters, and the like, and characteristics such as ciphertext size. For instance, cryptographic techniques (e.g., algorithms and/or specific configurations of algorithms) may be registered with library manager 240 along with information indicating characteristics of the cryptographic techniques. Examples of algorithms include the Paillier cryptosystem, the Boneh-Goh-Nissim cryptosystem, the Rivest-Shamir-Adleman (RSA) cryptosystem, the Gentry cryptosystem(s), the Brakerski-Gentry-Vaikuntanathan (BGV) cryptosystem(s), the Cheon, Kim, Kim and Song (CKKS) cyrptosystem(s), the Clear and McGoldrick multi-key homomorphic cryptosystem, data encryption standard (DES), triple DES, advanced encryption standard (AES), Diffie-Hellman (DH) encryption, Elliptic Curve DH (ECDH) encryption, digital signatures such as Digital Signature Algorithm (DSA) and Elliptic Curve DSA (ECDSA), cryptographic hash functions such as Secure Hash Algorithm 2 or 3 (SHA-2 or SHA-3), and others. There are many other types of encryption algorithms, including homomorphic and non-homomorphic encryption algorithms, and the algorithms listed herein are included as examples. Some algorithms may, for example, involve symmetric key encryption or asymmetric key encryption, digital signatures or cryptographic hash functions, and/or the like. A configuration of an algorithm may include values for one or more configurable parameters of the algorithm, such as key size, size of lattice, which elliptic curve is utilized, number of bits of security, whether accelerators are used, ciphertext size, and/or the like. A characteristic of a cryptographic technique may be, for example, whether the cryptographic technique is homomorphic, supported mathematical operations, how many times a given type of mathematical operation can be performed on data encrypted using the technique, whether the technique is Turing complete (e.g., supports all types of mathematical operations, such as a fully homomorphic encryption scheme), a security rating, a resource requirement rating, whether the technique requires an accelerator, whether the technique is quantum-safe, or the like. A cryptographic technique may include more than one cryptographic algorithm and/or configuration. In an example, each cryptographic technique is tagged (e.g., by an administrator) based on characteristics of the technique, such as with an indication of whether the technique is homomorphic, an indication of supported mathematical operations, an indication of how many instances of a given type of mathematical operation are supported, a security rating, an indication of threats protected against by the technique, indications of the resource requirements of the technique, and/or the like.

Information related to cryptographic techniques registered with library manager 240 may be stored in an available algorithm/configuration table. For instance, an available algorithm/configuration table may store identifying information of each available cryptographic technique (e.g., an identifier of a library, an identifier of an algorithm in the library, and/or one or more configuration values for the algorithm) associated with tags indicating characteristics of the technique. It is noted that policies and tags are examples of how cryptographic techniques may be associated with indications of characteristics, and alternative implementations are possible. For instance, rather than associating individual cryptographic techniques with tags, alternative embodiments may involve associating higher-level types of cryptographic techniques with tags, and associating individual cryptographic techniques with indications of types. For example, a higher-level type of cryptographic technique may be “homomorphic encryption algorithms configured to support addition.” Thus, if tags are associated with this type (e.g., including supported mathematical operations, security ratings, recourse requirement ratings, and the like), any specific cryptographic techniques of this type (being homomorphic encryption algorithms, and being configured to support addition) will be considered to be associated with these tags. In another example, fuzzy logic and/or machine learning techniques may be employed, such as based on historical cryptographic data indicating which cryptographic techniques were utilized for cryptographic requests having particular characteristics. In some embodiments, tags may be associated with specific configurations of cryptographic algorithms, such as assigning a security rating to a particular set of configuration parameters for a particular cryptographic algorithm or type of algorithm.

Tags associated with cryptographic techniques may be updated as appropriate over time, such as based on input from a user (e.g., an administrator, security operations professional, and/or the like). For example, a user may provide input upgrading or downgrading a security rating for a particular cryptographic technique, type of cryptographic technique, or configuration of a cryptographic technique (e.g., from 10 out of 10 to 8 out of 10), such as based on changed understandings of vulnerabilities or strengths of particular techniques.

By allowing cryptographic techniques and libraries, including new homomorphic encryption techniques that may become available due to the ongoing research into such algorithms, to be registered and deregistered with library manager 240 on an ongoing basis, and to be associated with metadata such as tags that can be dynamically updated, embodiments of the present disclosure allow the pool of possible cryptographic techniques to be continuously updated to meet new conditions and threats. For example, as new libraries are developed, these libraries may be added to library manager 240, and the cryptographic techniques in the library may be used by crypto provider 220 in servicing requests from application 210 without application 210 having any awareness of the new libraries. Similarly, by managing policies and libraries separately, policies may be defined in an abstract manner (e.g., based on characteristics of requests and cryptographic techniques) such that policies may be satisfied through the selection of new cryptographic techniques that were not known at the time of policy creation.

In one particular example, a new cryptographic technique is tagged as being fully homomorphic (e.g., Turing complete), meaning that the cryptographic technique was developed to support all types of mathematical operations in a homomorphic manner. For instance, the new cryptographic technique may have a high security rating (e.g., 10 out of 10) as well as high resource requirements. The new cryptographic technique is registered with library manager 240, and information about the new cryptographic technique and its characteristics is stored in an available algorithm/configuration table. Thus, the new cryptographic algorithm is available to be selected by crypto provider 220 for servicing cryptographic requests from application 210.

Continuing with the example, a policy states that cryptographic requests relating to data that is to be sent to an aggregator device for aggregation as part of a federated learning process is to be encrypted using a fully homomorphic technique if such a technique is available, unless device and/or network resource constraints prohibit the use of such a technique. Thus, when application 210 submits a cryptographic request 280 (e.g., via a call to a generic cryptographic function provided by abstracted crypto API 212) to encrypt an item of data that is to be sent to an aggregator device for aggregation as part of a federated learning process, crypto provider 220 determines based on information stored in the policy table that a fully homomorphic cryptographic technique is to be used if possible. Crypto provider 220 determines based on information in the available algorithm/configuration table that the new cryptographic technique is fully homomorphic. Next, crypto provider 220 analyzes resource constraints related to the cryptographic request 280 to determine if the new cryptographic technique can be performed. If crypto provider 220 determines that the device and/or network associated with application 210 can support the new cryptographic technique (e.g., based on available resources), then crypto provider 220 selects the new cryptographic technique for servicing the cryptographic request 280, and provides a response 282 to application 210 (e.g., via agility shim 214) accordingly. However, if crypto provider 220 determines that the device and/or network associated with application 210 cannot support the new cryptographic technique (e.g., based on available resources), then crypto provider 220 selects a different cryptographic technique for servicing the cryptographic request 280, such as a different homomorphic encryption technique that supports the mathematical operations indicated in request 280 and that otherwise complies with the resource constraints of the device and/or network, and provides a response 282 to application 210 (e.g., via agility shim 214) accordingly.

In some cases, the response sent from crypto provider 220 to application 210 includes data encrypted using the selected technique. In other cases, the response includes information related to performing the selected technique to encrypt the data, and the encryption is performed on the device from which the request was sent. In still other cases, one or more other components and/or devices may be involved in performing the encryption according to the technique selected by crypto provider 220.

In some cases, more than one cryptographic technique may be selected for servicing a given cryptographic request. For instance, an item of data may first be encrypted using a first technique (e.g., that satisfies one or more first conditions related to policy and/or resource considerations) and then the encrypted data may be encrypted again using a second technique (e.g., that satisfies one or more second conditions related to policy and/or resource considerations). For example, a dual or multi-encryption scheme such as composite encryption or hybrid encryption may be employed for servicing a single cryptographic request.

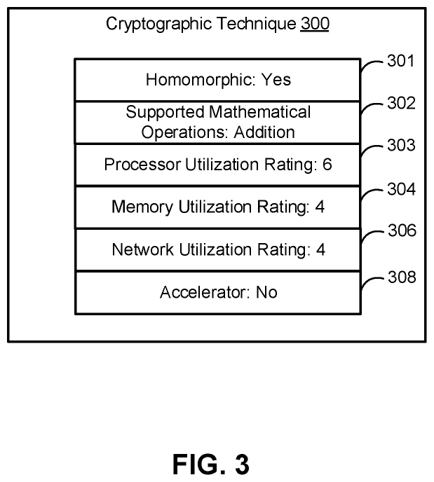

FIG. 3 depicts an example of tagging cryptographic techniques based on attributes, including tagging homomorphic encryption techniques with supported mathematical operations.

A cryptographic technique 300 comprises one or more cryptographic algorithms and/or configurations of algorithms. For instance cryptographic technique 300 may be included in a cryptographic library, and may be registered with library manager 240 of FIG. 2 as an available cryptographic technique for use in a cryptographic agility system.

Tags 301, 302, 303, 304, 306, and 308 are associated with cryptographic technique 300 to indicate characteristics of cryptographic technique 300. For example, these tags may be added by an administrator at the time cryptographic technique 300 is registered with library manager 240 of FIG. 2. While not depicted, cryptographic technique 300 may also be associated with other tags related to, for example, a security level of cryptographic technique 300, threats protected against by cryptographic technique 300, whether cryptographic technique 300 is quantum-safe, and/or the like.

Tags 301, 302, 303, 304, 306, and 308 may be based on a variety of characteristics of cryptographic technique 300, such as the nature of involved cryptographic algorithm(s), key size, size of lattice, which elliptic curve is utilized, number of bits of security, whether accelerators are used, ciphertext size, whether side channel attacks are protected against (e.g., resulting in higher resource usage), and/or the like.

Tag 301 indicates that cryptographic technique 300 is a homomorphic encryption technique.

Tag 302 indicates that cryptographic technique 300 supports the mathematical operation of addition, such as meaning that addition can be performed on data encrypted using cryptographic technique 300 without decryption in order to produce an encrypted result that, when decrypted using cryptographic technique 300, is the same as the result would have been if the addition operation had been performed on the unencrypted data. While not shown, one or more additional tags may indicate how many times each given supported type of mathematical operation can be performed on data encrypted using cryptographic technique 300 (e.g., while still maintaining homomorphic properties).

Tag 303 indicates a processor utilization rating of 6. In an example, processor utilization ratings may range from 0-10, and generally indicate an amount of processing resources required by a cryptographic technique.

Tag 304 indicates a memory utilization rating of 4. In an example, memory utilization ratings may range from 0-10, and generally indicate an amount of memory resources required by a cryptographic technique.

Tag 306 indicates a network utilization rating of 4. In an example, network utilization ratings may range from 0-10, and generally indicate an amount of network resources required by a cryptographic technique.

Tag 308 indicates that an accelerator is not used by cryptographic technique 300.

Tags 301, 302, 303, 304, 306, and 308 are included as examples, and other types of tags may be included. Tags 301, 302, 303, 304, 306, and 308 generally allow a cryptographic agility system to identify which cryptographic techniques are best suited for a given cryptographic request, such as related to a federated learning process, based on various characteristics.

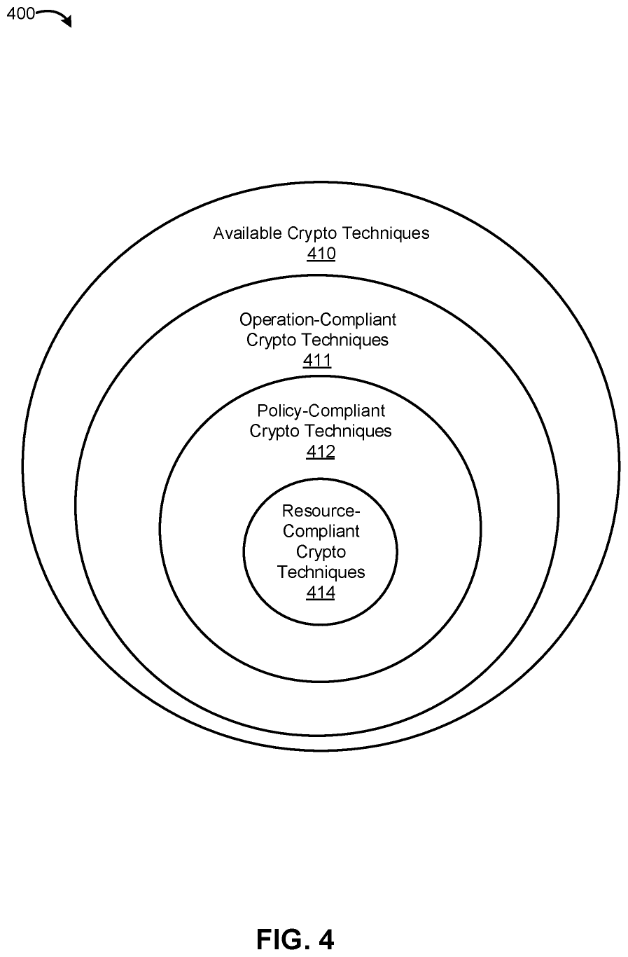

FIG. 4 is a diagram 400 depicting an example related to dynamic cryptographic technique selection for privacy-preserving federated learning.

Diagram 400 depicts a set of available crypto techniques 410. Available crypto techniques 410 includes all cryptographic techniques that have been registered with a cryptographic agility system, as described above with respect to FIGS. 1-3.

Within the set of available crypto techniques 410 is a subset including operation-compliant crypto techniques 411. For example, if the given cryptographic request relates to a federated learning process, operation-compliant crypto techniques 411 may include all homomorphic cryptographic techniques within available crypto techniques 410 that support the mathematical operations that are to be performed by an aggregator device with respect to the encrypted data (e.g., these operations may be indicated in the cryptographic request and/or otherwise determined based on the cryptographic request).

Within the set of operation-compliant techniques 411 is a subset include policy-compliant crypto techniques 412. Policy-compliant crypto techniques 412 generally includes all available cryptographic techniques (e.g., within operation-compliant crypto techniques 311) that comply with applicable policies for servicing a given cryptographic request. For example, policy-compliant crypto techniques 412 may include all techniques that meet a minimum security rating required by a policy, such as based on contextual information associated with the given cryptographic request.

Within the set of policy-compliant crypto techniques 412 is a subset including resource-compliant crypto techniques 414. Resource-compliant crypto techniques 414 generally include all policy-compliant cryptographic techniques 412 that are consistent with resource constraints related to the given cryptographic request. For instance, resource-compliant crypto techniques 414 may include all techniques within policy-compliant crypto techniques 412 that are compatible with the processing, memory, network, and/or capability constraints associated with the given cryptographic request.

A cryptographic technique may be selected for servicing the given cryptographic request from resource-compliant crypto techniques 414. For instance, the most secure technique in resource-compliant crypto techniques 414 may be selected.

Diagram 400 demonstrates an example hierarchy of compliance with policies, operation constraints, and resource constraints. In other embodiments, one or more policies may relate to operation and/or resource constraints, and so compliance with policies may imply compliance with operation and/or resource constraints. Furthermore, the example hierarchy of compliance is included as an example, and other hierarchies are possible. Additionally, there may be cases where there is no available cryptographic technique that complies with all policies, operation constraints, and resource constraints, and so trade-offs may be made (e.g., in accordance with policies and/or logic governing such cases), such as selecting a cryptographic technique that is not fully compliant with one or more of these factors (e.g., if certain factors are non-mandatory), or certain cryptographic requests may be declined as impossible under the circumstances.

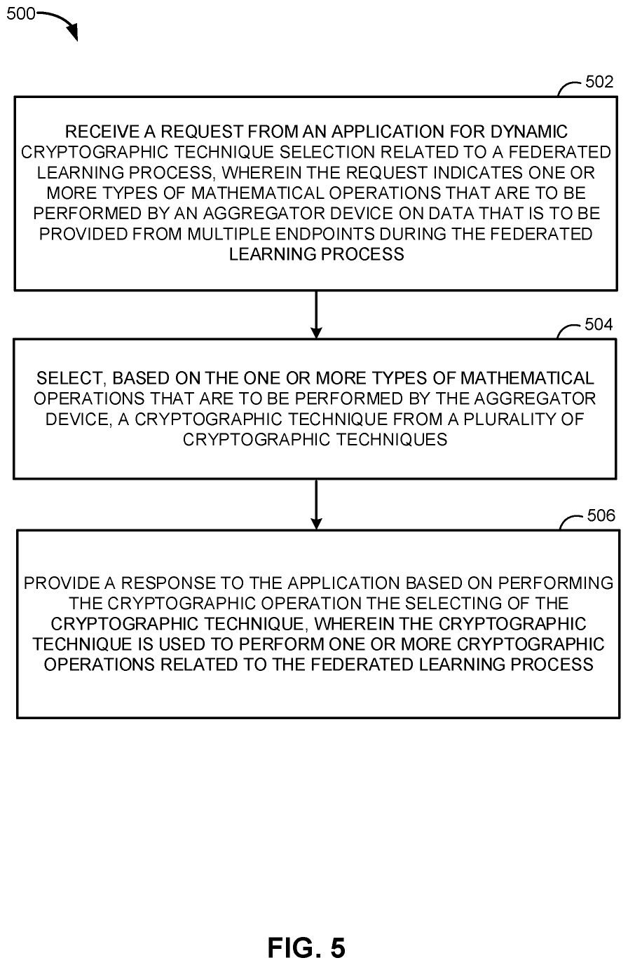

FIG. 5 depicts example operations 500 for dynamic cryptographic technique selection for privacy-preserving federated learning according to embodiments of the present disclosure. For example, operations 500 may be performed by one or more components of the cryptographic agility system described above with respect to FIGS. 1-4.

Operations 500 begin at step 502, with receiving a request from an application for a cryptographic operation related to a federated learning process, wherein the request indicates one or more types of mathematical operations that are to be performed by an aggregator device on data that is to be provided from multiple endpoints during the federated learning process. It is noted that the aggregator device may be a centralized aggregator device to which a plurality of endpoints (e.g., including the application) are to send data for aggregation or a decentralized federated learning process may be employed in which the aggregator device is one of the endpoints participating in the federated learning process and performs aggregation on its local data along with data received from one or more other endpoints (e.g., including the application) participating in such a decentralized federated learning process.

Furthermore, it is noted that “the application” may refer to one of the endpoints of the federated learning process, or may refer to a centralized component that orchestrates cryptography across the multiple endpoints for the federated learning process and may not necessarily be one of the endpoints. In one embodiment, the application is the aggregator device or runs on the aggregator device.

Operation 500 continue at step 504, with selecting, based on the one or more types of mathematical operations that are to be performed by the aggregator device, a cryptographic technique from a plurality of cryptographic techniques.

In some embodiments, the cryptographic technique comprises a homomorphic encryption algorithm. In certain embodiments, selecting the cryptographic technique from the plurality of cryptographic techniques comprises determining, based on one or more tags associated with the cryptographic technique, that the homomorphic encryption algorithm supports the one or more types of mathematical operations. In some embodiments, selecting the cryptographic technique is further based on one or more capabilities of a device associated with the request.

In certain embodiments, selecting the cryptographic technique is further based on one or more resource constraints of a device associated with the request. Some embodiments further comprise determining not to select a fully homomorphic encryption algorithm as the encryption technique based on the one or more resource constraints of the device associated with the request.

In some embodiments, selecting the cryptographic technique is further based on how many times the one or more types of mathematical operations are to be performed during the federated learning process, which may be indicated in the request.

In certain embodiments, selecting the cryptographic technique is based on one or more policies relating to cryptographic technique selection. For example, some embodiments further comprise receiving the one or more policies from a policy control server.

Operations 500 continue at step 506, with providing a response to the application based on the selecting of the cryptographic technique, wherein the cryptographic technique is used to perform one or more encryption operations related to the federated learning process.

In some embodiments, a given endpoint of the multiple endpoints transmits encrypted data to the aggregator device based on the response, and the aggregator device performs the one or more types of mathematical operations on the encrypted data and corresponding encrypted data from one or more additional endpoints of the multiple endpoints. The application may be the given endpoint. In another embodiment, the application is a centralized orchestration component, and the centralized orchestration component provides information about the encryption technique to the given endpoint based on the response. For example, the aggregator device may not be granted access to an unencrypted form of the encrypted data.

In certain embodiments, the aggregator device sends the given endpoint a result of performing the one or more types of mathematical operations on the encrypted data and the corresponding encrypted data, and the given endpoint obtains a decrypted version of the result based on an encryption key used to produce the encrypted data.

In some embodiments, selecting the cryptographic technique is based on one or more policies relating to cryptographic technique selection. For example, the one or more policies may be received from a policy control server.

In certain embodiments, selecting the cryptographic technique is further based on one or more of: a network constraint; an application characteristic; a user characteristic; a data privacy classification level; or a compliance requirement.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of cryptographic agility for privacy-preserving federated learning, comprising:
receiving a request from an application for dynamic cryptographic technique selection related to a federated learning process, wherein the request indicates one or more types of mathematical operations that are to be performed by an aggregator device on data that is to be provided from multiple endpoints during the federated learning process;
selecting, based on the one or more types of mathematical operations that are to be performed by the aggregator device, a cryptographic technique from a plurality of cryptographic techniques; and
providing a response to the application based on the selecting of the cryptographic technique, wherein the cryptographic technique is used to perform one or more cryptographic operations related to the federated learning process.

2. The method of claim 1, wherein the cryptographic technique comprises a homomorphic encryption algorithm.

3. The method of claim 2, wherein selecting the cryptographic technique from the plurality of cryptographic techniques comprises determining, based on one or more tags associated with the cryptographic technique, that the homomorphic encryption algorithm supports the one or more types of mathematical operations.

4. The method of claim 1, wherein selecting the cryptographic technique is further based on one or more capabilities of a device associated with the request.

5. The method of claim 1, wherein selecting the cryptographic technique is further based on one or more resource constraints of a device associated with the request.

6. The method of claim 5, further comprising determining not to select a fully homomorphic encryption algorithm as the cryptographic technique based on the one or more resource constraints of the device associated with the request.

7. The method of claim 1, wherein a given endpoint of the multiple endpoints transmits encrypted data to the aggregator device based on the response, and wherein the aggregator device performs the one or more types of mathematical operations on the encrypted data and corresponding encrypted data from one or more additional endpoints of the multiple endpoints.

8. The method of claim 7, wherein the application is the given endpoint.

9. The method of claim 7, wherein the application is a centralized orchestration component, and wherein the centralized orchestration component provides information about the cryptographic technique to the given endpoint based on the response.

10. The method of claim 7, wherein the aggregator device is not granted access to an unencrypted form of the encrypted data.

11. The method of claim 10, wherein the aggregator device sends the given endpoint a result of performing the one or more types of mathematical operations on the encrypted data and the corresponding encrypted data, and wherein the given endpoint obtains a decrypted version of the result based on an encryption key used to produce the encrypted data.

12. The method of claim 10, wherein selecting the cryptographic technique is further based on a respective number of times each respective type of mathematical operation of the one or more types of mathematical operations is to be performed.

13. The method of claim 1, wherein selecting the cryptographic technique is based on one or more policies relating to cryptographic technique selection.

14. The method of claim 13, further comprising receiving the one or more policies from a policy control server.

15. The method of claim 1, wherein selecting the cryptographic technique is further based on one or more of:
a network constraint;
an application characteristic;
a user characteristic;
a data privacy classification level; or
a compliance requirement.

16. A system for cryptographic agility for privacy-preserving federated learning, comprising:
at least one memory; and
at least one processor coupled to the at least one memory, the at least one processor and the at least one memory configured to:
receive a request from an application for dynamic cryptographic technique selection related to a federated learning process, wherein the request indicates one or more types of mathematical operations that are to be performed by an aggregator device on data that is to be provided from multiple endpoints during the federated learning process;
select, based on the one or more types of mathematical operations that are to be performed by the aggregator device, a cryptographic technique from a plurality of cryptographic techniques; and
provide a response to the application based on the selecting of the cryptographic technique, wherein the cryptographic technique is used to perform one or more cryptographic operations related to the federated learning process.

17. The system of claim 16, wherein the cryptographic technique comprises a homomorphic encryption algorithm.

18. The system of claim 17, wherein selecting the cryptographic technique from the plurality of cryptographic techniques comprises determining, based on one or more tags associated with the cryptographic technique, that the homomorphic encryption algorithm supports the one or more types of mathematical operations.

19. The system of claim 16, wherein selecting the cryptographic technique is further based on one or more capabilities of a device associated with the request.

20. A non-transitory computer readable medium storing instructions that, when executed by one or more processors, cause the one or more processors to:
receive a request from an application for dynamic cryptographic technique selection related to a federated learning process, wherein the request indicates one or more types of mathematical operations that are to be performed by an aggregator device on data that is to be provided from multiple endpoints during the federated learning process;
select, based on the one or more types of mathematical operations that are to be performed by the aggregator device, a cryptographic technique from a plurality of cryptographic techniques; and
provide a response to the application based on the selecting of the cryptographic technique, wherein the cryptographic technique is used to perform one or more cryptographic operations related to the federated learning process.
